(19) United States
(12) Patent Application Publication
(10) Pub. No.: US 2015/0121348 A1
(43) Pub. Date: Apr. 30, 2015

(54) METHOD AND DEVICE FOR ANALYZING APPLICATION

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Ji-soon PARK, Seoul (KR); Jin-yung KIM, Seoul (KR); Yong-ho YOON, Seoul (KR); Jun-bum SHIN, Suwon-si (KR); Kwang-keun YI, Seoul (KR)

(73) Assignees: SEOUL NATIONAL UNIVERSITY R&DB FOUNDATION, Seoul (KR); SAMSUNG ELECTRONICS CO., LTD., Suwon-si (KR)

(21) Appl. No.: 14/524,264

(22) Filed: Oct. 27, 2014

(30) Foreign Application Priority Data
Oct. 25, 2013 (KR) 10-2013-0128034

(51) Int. Cl. G06F 11/36; G06F 9/45

(52) U.S. Cl. CPC G06F 11/3612; G06F 8/51
USPC 717/131

(57) ABSTRACT

A method and device for analyzing an application are provided. The method includes obtaining the application, obtaining at least one of environment information, which is information about an environment where the application is executed, and execution information, which is information about operations of components of the application, obtaining code data to analyze from the application, based on at least one of the environment information and the execution information, obtaining function information, and analyzing the code data, based on the obtained function information.

### RELATED APPLICATION

This application claims priority from Korean Patent Application No. 10-2013-0128034, filed on Oct. 25, 2013 in the Korean Intellectual Property Office, the disclosure of which is incorporated herein in its entirety by reference.

### BACKGROUND

1. Field

Methods and apparatuses consistent with exemplary embodiments relate to a method of analyzing an application, and more particularly, to a static analysis method with respect to an application, and a device performing the method.

2. Description of the Related Art

Recently, smart devices including smart phones, tablet personal computers (PCs), smart televisions (TVs), or electronic readers have become widely used. Accordingly, the types and number of applications which can be used in the smart devices have sharply increased.

Due to the increase in the types and the number of applications which are being used, there is a demand for performing application analysis so as to provide safe and accurate applications to users. Application analysis includes a dynamic analysis method and a static analysis method. The dynamic analysis method is performed by executing an application, however, the dynamic analysis may cause deterioration in the functions of the application, and it is difficult to execute all of the operations of the application. Thus, the static analysis method may be preferred.

However, since the static analysis method involves analyzing the application only based on the code in the application, the accuracy and performance may deteriorate, and when the application includes code generated by different types of languages, it is impossible to perform an efficient analysis.

Therefore, there is a demand for a method of improving the performance and accuracy of the static analysis method with respect to applications.

### SUMMARY

According to an aspect of an exemplary embodiment, there is provided a method of analyzing an application which is performed by a device, the method including obtaining the application; obtaining at least one of environment information of the device, which is information about an environment where the application is executed, and execution information, which is information about operations of components of the application; obtaining code data to analyze from the application, based on at least one of the environment information and the execution information; obtaining function information; and analyzing the code data, based on the obtained function information.

The method may further include an operation of converting the code data to an intermediate language code, and wherein the analyzing the code data includes analyzing the intermediate language code based on the function information.

The code data of the application may include first code data written in a first language and second code data written in a second language, wherein the converting the code data to the intermediate language code comprises converting each of the first code data written in the first language and the second code data written in the second language to the intermediate language code, based on the execution information, and the analyzing the code data may include an operation of analyzing the converted first code data written in the first language and analyzing the converted second code data written in the second language, based on the function information.

The analyzing the converted first code data may include operations of obtaining analysis information with respect to the converted second code data written in the second language; and analyzing the converted first code data written in the first language, based on the function information and the analysis information with respect to the converted second code data written in the second language.

The converting the code data may include extracting a non-executed component of the application, based on the execution information; and converting the code data that corresponds to the components of the application, excluding the non-executed component, to the intermediate language code.

The converting the code data may include mapping one or more functions included in the code data to a group, according to a predetermined reference, and converting the one or more functions included in the group to the intermediate language code.

The converting the code data may include converting a function included in the code data to a combination of one or more intermediate language codes, according to a predetermined reference in the code data.

The method may further include determining, based on a result of the analyzing the code data, whether the application transmits an information resource of the device to an external device.

The method may further include obtaining external reference information related to the code data of the application, and the analyzing may include analyzing the intermediate language code based on the function information and the external reference information.

The analyzing may include tracking a task to be performed by the application, based on the obtained function information.

The function information may include at least one of application programming interface (API) operating information, API parameter information, and function operating information.

The environment information of the device may include at least one of operating system (OS) information and platform information of the device.

The execution information may include lifecycle information about each of the components of the application.

According to one or more exemplary embodiments, a non-transitory computer-readable recording medium includes a recorded program for executing the method by using a computer.

According to an aspect of another exemplary embodiment, there is provided a device capable of analyzing an application, the device including a characteristic information obtainer configured to obtain at least one of environment information of the device, which is information about an environment where the application is executed, and execution information, which is information about operations of components of the application; an application obtainer configured to obtain the application and configured to obtain code data to analyze from the application, based on at least one of the environment information and the execution information; a function information obtainer configured to obtain function information; and an application analyzer configured to analyze the code data, based on the obtained function information.

The device may further include an intermediate language converter configured to convert the code data to an intermediate language code, and the application analyzer is configured to analyze the intermediate language code, based on the obtained function information.

The code data of the application may include first code data written in a first language and second code data written in a second language, and the intermediate language converter is configured to convert each of the first code data written in the first language and the second code data written in the second language to the intermediate language code, based on the execution information, and the application analyzer is configured to analyze the converted first code data written in the first language and configured to analyze the converted second code data written in the second language, based on the function information.

The device may further include an analysis information provider configured to obtain analysis information with respect to the converted second code data written in the second language, and the application analyzer is configured to analyze the converted first code data written in the first language, based on the function information and the analysis information with respect to the converted second code data written in the second language.

The intermediate language converter is configured to extract a non-executed component of the application, based on the execution information, and configured to convert the code data that corresponds to the components of the application excluding the non-executed component, to the intermediate language code.

The intermediate language converter is configured to map one or more functions included in the code data to a group, according to a predetermined reference, and is configured to convert the one or more functions included in the group to the intermediate language code.

The intermediate language converter is configured to convert a function included in the code data to a combination of one or more intermediate language codes, according to a predetermined reference in the code data.

The device may further include a determiner configured to determine, based on a result of the analyzing, whether the application transmits an information resource of the device to an external device.

The device may further include an external reference information obtainer configured to obtain external reference information related to the code data of the application, and the application analyzer is configured to analyze the intermediate language code, based on the function information and the external reference information.

The application analyzer may track a task to be performed by the application, based on the function information.

The function information may include at least one of application programming interface (API) operating information, API parameter information, and function operating information.

The environment information of the device may include at least one of operating system (OS) information and platform information of the device.

The execution information may include lifecycle information about each of the components of the application.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 illustrates a static analysis system with respect to an application according to an exemplary embodiment;

FIG. 2 is a flowchart of a method of analyzing an application, according to an exemplary embodiment;

FIG. 3 illustrates a device that analyzes an application, according to an exemplary embodiment;

FIG. 4 is a flowchart of a method of analyzing an application, according to another exemplary embodiment;

FIG. 5 is a flowchart of a method of analyzing an application, according to another exemplary embodiment;

FIG. 6 is a flow diagram of a method of analyzing an application, according to another exemplary embodiment;

FIG. 7 is a flowchart of a method of analyzing an application, according to another exemplary embodiment;

FIG. 8 illustrates an example of converting to an intermediate language code, according to an exemplary embodiment;

FIG. 9 illustrates a method of analyzing code data composed of different types of languages, according to an exemplary embodiment; and

FIG. 10 illustrates a method of analyzing code data composed of different types of languages, according to another exemplary embodiment.

### DETAILED DESCRIPTION

Hereinafter, terms or expressions used in the specification are briefly described, and then one or more exemplary embodiments are described in detail.

All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the exemplary embodiments. Thus, the terms used herein should be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a component for processing at least one function or operation, and the unit and the block may be embodied as hardware, such as a processor or circuit, or software that is stored in recording medium or memory and executed by a hardware component such as a processor, or embodied by combining hardware and software.

Throughout the specification, code data may include a source code, a machine code, or an assembly code, and may include all of a plurality of pieces of code-form data that are included in an application and are written in a particular language so as to drive the application. Also, the code data may be a file including a source code and a machine language code, but one or more exemplary embodiments are not limited thereto.

Throughout the specification, a function includes an instruction and may indicate a code or a sequence of codes for performing a particular operation in software such as an application, but one or more exemplary embodiments are not limited thereto.

Throughout the specification, an application may include not only the application itself but also may include a program or an application package. However, one or more exemplary embodiments are not limited thereto, that is, the application may include all software including code data.

The exemplary embodiments will now be described more fully with reference to the accompanying drawings, in which exemplary embodiments are shown. The exemplary embodiments may, however, be embodied in many different forms and should not be construed as being limited to the exemplary embodiments set forth herein. Rather, these exemplary embodiments are provided so that this disclosure will be thorough and complete, and will fully convey the concept of the exemplary embodiments to those of ordinary skill in the art. In the following description, well-known functions or constructions are not described in detail since they would obscure the exemplary embodiments with unnecessary detail. Throughout the specification, like reference numerals in the drawings denote like elements.

As used herein, the term “and/or” includes any and all combinations of one or more of the associated listed items. Expressions such as “at least one of,” when preceding a list of elements, modify the entire list of elements and do not modify the individual elements of the list.

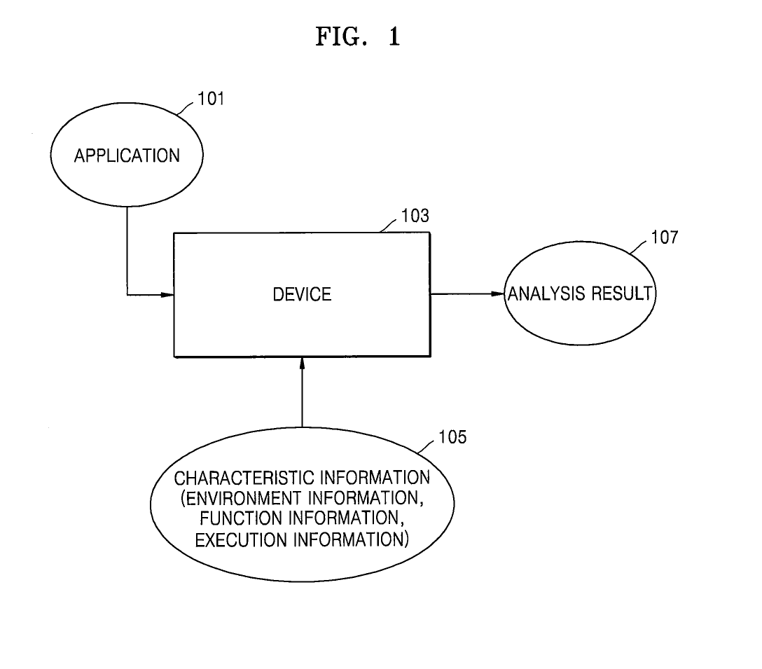

FIG. 1 illustrates a static analysis system with respect to an application according to an exemplary embodiment.

As illustrated in FIG. 1, in the static analysis system, a device 103 obtains an application 101, analyzes the obtained application 101, and thus provide an analysis result 107 to a user. However, not all elements shown in FIG. 1 are necessary elements. That is, the static analysis system may be realized with more or fewer elements than the elements shown in FIG. 1.

According to the present exemplary embodiment, the device 103 obtains the application 101 through various ways. The device 103 may obtain the application 101 from a server such as Google Play™ store or the Apple® App Store®. Alternatively, the device 103 may obtain the application 101 from an external device or a storage in the device 103.

In the present exemplary embodiment, the device 103 that analyzes the application 101 may be embodied in various forms. For example, the device 103 in one or more exemplary embodiments may include, but is not limited to, a desktop computer, a mobile phone, a smart phone, a laptop computer, a tablet personal computer (tablet PC), an electronic book terminal, a terminal for digital broadcasting, a personal digital assistant (PDA), a portable multimedia player (PMP), a navigation device, an MP3 player, a digital camera, an Internet protocol television (IPTV), a digital TV (DTV), and consumer electronic devices (CE devices), such as a refrigerator or an air-conditioner having a display device.

In the present exemplary embodiment, the application may include a program that includes code data. For example, the application may indicate all software that is executed as application software in an operating system (OS).

The code data included in the application 101 may include a file that stores a machine language.

Also, the device 103 may obtain the application 101, may convert the code data to an assembly code that corresponds to a platform in which the obtained application 101 is executed, and may extract code data that is converted to the assembly code. For example, the device 103 may extract code data in the form of bytecode that is executed in the Dalvik virtual machine, from an application executed in an Android™ platform.

The application 101 can include components that configure the application 101. The components of the application 101 can include objects, and each of the objects can include a sequence of code data. The object can include a function and an instruction that has a particular attribute and that performs a particular operation, and may indicate a sequence of languages included in the code data. Since the object is obvious to one of ordinary skill in the art, detailed descriptions thereof are not repeated.

The components of the application 101 may include, but are not limited to, an activity, a service, or the like.

The device 103 may obtain the code data from the application 101, may analyze the obtained code data, and thus may provide an analysis result to a user.

In the present exemplary embodiment, the analysis of the code data may mean static analysis. Static analysis of code is performed without actually executing programs.

The device 103 may translate the code data obtained from the application 101 to an intermediate language code, may analyze the intermediate language code, and thus may provide an analysis result to the user. The intermediate language code is language which is designed to assist in analyzing the program.

In addition, according to the present exemplary embodiment, the device 103 may determine, based on the analysis result, whether an information resource of the device 103 is externally transmitted.

Throughout the specification, the information resource of the device 103 may include user's personal information stored in the device 103, such as, pin number (PIN) information, account information, identification (ID) information of the user, ID information of the device 103, and user experience information such as photos, memos, an address book or an internet access record that may be obtained by the application 101 in the device 103.

In the present exemplary embodiment, the device 103 may obtain characteristic information 105 and may analyze the application 101 based on the characteristic information 105. The characteristic information 105 may include at least one of environment information about the device 103 in which the application 101 is executed, function information, and execution information about operations of the components that configure the application 101.

The environment information about the device 103 in which the application 101 is executed may include, but is not limited to, at least one of platform information, OS information, model information, and performance information about the device 103 in which the application 101 is executed. For example, the environment information may include, but is not limited to, information about whether the device 103 in which the application 101 is executed is one of the Galaxy® series developed by Samsung® or one of iPhone® series developed by Apple®, information about whether an environment in which the application 101 is executed is an Android™ OS or an iOS of Apple®, or device performance information about whether the device 103 supports high definition (HD) image quality.

According to the present exemplary embodiment, a platform may indicate a structure for executing software, and may include all hardware and software configurations that provide application program development and execution environments. Also, the OS means an interface that drives the hardware. Since the platform and the OS are obvious to one of ordinary skill in the art, additional descriptions thereof are not repeated.

The function information may include information about a function such as an application programming interface (API) that the OS or the platform provides. That is, the function information may include information about operations of functions that are provided by the OS or the platform, and a plurality of pieces of parameter information included in the function. In addition, the function information may include a plurality of pieces of information in a library provided by the OS or the platform.

According to the present exemplary embodiment, the API may indicate the function set for allowing the application 101 to use basic functions of the OS.

The execution information about the operations of the components that configure the application 101 may include information about an operation of an object that is one of the components that configure the application 101. For example, the execution information may include a plurality of pieces of information about a function used by the object, another function and object that are called by the object, and operations of the object according to a lifecycle of the object.

In addition, the execution information may include information for estimating operations of the components of the application 101 in the device 103. However, the types of execution information are not limited to these examples.

According to the present exemplary embodiment, the components that configure the application 101 may vary according to an environment of the OS in which the application 101 is executed. Also, the execution information that is information about operations of the components of the application 101 may include information about a structure of an activity that is the component of the application 101, information about calling the activity, and information about an intent for executing each of the activities.

The activity may be the component of the application 101 which is an object that corresponds to one screen of the application 101. The intent may be the component of the application 101 which calls one of the components of the application 101 or designates an operation of one of the components of the application 101. The intent itself may be an object that configures the application 101.

The device 103 may obtain the code data to be analyzed from the application 101 based on at least one of the environment information and the execution information.

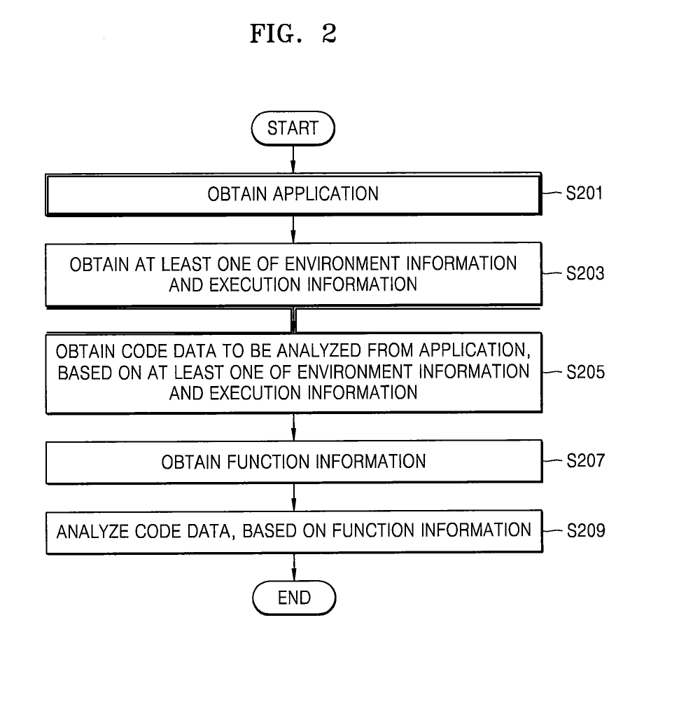

Also, the device 103 may obtain the function information, and may analyze the code data, based on the function information. Detailed descriptions thereof are provided with reference to FIG. 2.

FIG. 2 is a flowchart of a method of analyzing an application, according to an exemplary embodiment.

In operation S201, a device may obtain the application. In the present exemplary embodiment, the application may include programs that include code data.

The application may be indicated by ‘App’ which is application software and may include all programs that are executable in various programming languages, such as Java, C or C++, various platforms, and various OSs.

The device may obtain the application through various ways. That is, the device may obtain the application from a storage of the device or from a server such as Google Play™ store, the Apple® App Store®, or the like. Also, the device may obtain the application by receiving the application from an external device.

The application may include code data of the application, and authority request information about information and functions that are accessible to the application. That is, the application in one or more exemplary embodiments may include an application package.

In operation S203, the device may obtain at least one of environment information and execution information of the device.

In the present exemplary embodiment, the environment information of the device may include at least one of OS information, platform information, and performance information about the device in which the application is executed. Since this has already been described with reference to FIG. 1, detailed descriptions thereof are not repeated.

The execution information may include information about the operations of components that configure the application. Since this has already been described with reference to FIG. 1, detailed descriptions thereof are not repeated.

The device may obtain the environment information and the execution information of the device, based on a user input. That is, the device may obtain, from a user via a user interface, such as a keyboard, touch screen, button, or key the environment information and the execution information about the device, in which the application to be analyzed, is to be executed.

In operation S205, the device may obtain code data to be analyzed from the application, based on at least one of the environment information and the execution information.

The application may include the code data that corresponds to various platform versions and various types of OSs, so as to allow the application to be executed in the various different platform versions and the various types of OSs. For example, the application may be written in the code data of the application that a first function is executed if an environment in which the application is executed is an Android™ OS, and a second function is executed if the environment is an iOS. Also, it may be written in the code data of the application that, according to a version of a platform, a first object is called if an Android™ OS version is less than 3.0, and a second object is called if the Android™ OS version is equal to or greater than 3.0.

Since the code data of the application may correspond to the various platform versions and the various types of OSs, the device may obtain the code data to be analyzed from the application, based on the environment information of the device in which the application is to be executed. That is, the device may select only parts of the code data, in consideration of the environment information, and may analyze the selected parts of the code data.

In the present exemplary embodiment, the device analyzes the code data while the device excludes unnecessary parts of the code data, so that an analysis performance with respect to the application may be improved.

When the device obtains a plurality of applications, the device may select one of the plurality of applications, based on the environment information, and may exclude the rest of the applications from the analysis.

In addition, if the application stores a plurality of files of code data, the device may select one of the files, based on the environment information, and may analyze the selected file.

In the present exemplary embodiment, the device may obtain the code data to be analyzed based on the execution information.

As described with reference to FIG. 1, the execution information may include information about operations of components of the application, and lifecycle information of the components.

The device may obtain the execution information and thus may determine which part of the code data is not executed in the application. For example, it is assumed that a part of the code data of the application is implemented so as to be executed as a administrator mode according to a first function call. The administrator mode may be a mode which is used when an administrator develops or tests an application. In this case, when the device determines, based on the execution information, that the first function call does not exist, the device may analyze the code data, except for the part of the code data that is implemented to be executed as the administrator mode.

In the present exemplary embodiment, the execution information may include lifecycle information of an activity of the application. As described with reference to FIG. 1, the activity may be an object that configures the application, and the lifecycle information may indicate information about a procedure in which a state of the object is changed from a start of the object to the end of the object.

In the present exemplary embodiment, the device may obtain the execution information and thus may obtain a plurality of pieces of lifecycle information of objects that configure the application, so that the device may analyze the code data, except for sub-code data that is implemented to execute an activity that is not executed.

In the present exemplary embodiment, sub-code data that is from among the code data for executing an activity and is not involved with starting or generating the activity may be excluded from the code data to be analyzed. Also, since a call path between activities may be recognized according to the lifecycle information, an activity that is included in the code data but is not called may be excluded. The sub-code data is a part of code data that is not executed in the application. Thus, activity that is implemented by the sub-code data is not practically executed.

For example, when the code data of the application includes an activity that is executable after a next update, the activity is implemented in the code data but is not currently called, and thus, the device may analyze the code data except for the activity.

When the device analyzes the code data, the device may add a tag to the code data that identifies the lifecycle information. That is, the device may clearly indicate a lifecycle of an object by using a tag.

In the present exemplary embodiment, the device may analyze the application by using a static analysis method.

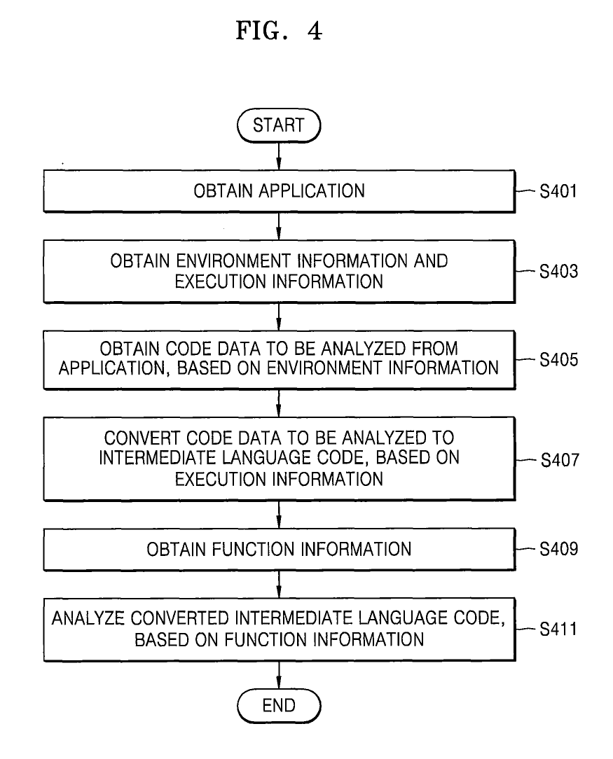

In addition, according to the present exemplary embodiment, the device may convert the code data to an intermediate language code. Also, the device may convert the code data to the intermediate language code, based on the execution information. This will be described in detail with reference to FIG. 4.

In operation S207, the device may obtain function information.

As described with reference to FIG. 1, the function information may include at least one of API operating information, API parameter information, and function operating information. That is, according to the present exemplary embodiment, the function information may include information about how an instruction or a function practically operates in the application.

For example, when a function ‘sum’ performs an operation of adding two variables, the device may determine, based on the function information, that the function ‘sum’ included in the code data of the application is set to perform the operation of adding two variables. An API indicates a function set or a collection of subroutines that are called by the application for an OS, and since the device obtains information about which API performs which operation, the device may determine which operation is performed by the code data.

In addition, the device may obtain function information, based on a user input.

In operation S209, the device may analyze the code data, based on the function information.

The device may analyze, based on the function information, which operation is performed by the code data. Since the function information includes information about operations that are performed by a function, an API, and an instruction, the device may accurately and rapidly analyze the operations of the function, the API, the instruction, or the like in the code data.

The device may track, based on the function information, a task to be performed by the application.

In the present exemplary embodiment, the task may mean an operation performed by the application and may include an operation of the device which is caused by executing the application. For example, a camera application may perform, via the device, a task of capturing an image of a subject, a task of generating image data, a task of storing the generated image data, and a task of transmitting the image data to another device by using a transmitter (not shown) of the device.

Since the task of the application is performed based on the code data of the application, the task of the application may be tracked, predicted, and/or estimated by analyzing the code data.

In addition, the device may determine whether the application transmits an information resource of the device to an external device. Based on a result of analyzing the code data of the application, the device may determine whether user information included in the device has been transmitted to the external device.

The device may obtain external reference information related to the code data, and may analyze the code data, based on the function information and the external reference information.

In the present exemplary embodiment, the external reference information may describe an external reference that involves using at least one variable or at least one object of another application or program in which the variable or the object are not defined by or included in the code data.

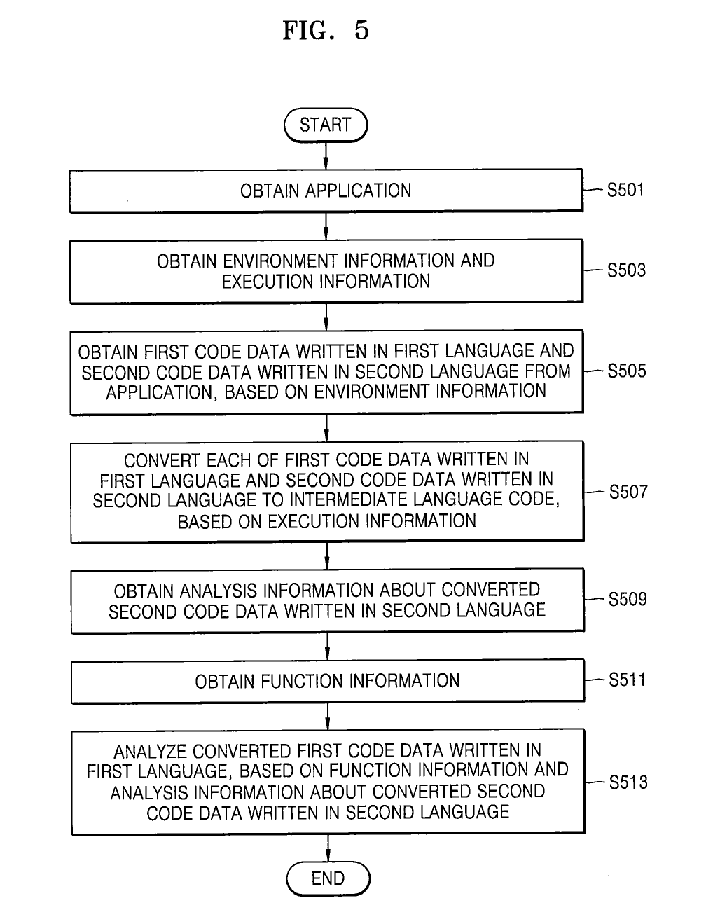

In addition, if the code data includes a first language and a second language, the device may analyze each part of the code data that is written in the first language and another part of the code data that is written in the second language, and may analyze the part of the code data written in the first language, based on the function information and the analysis information about the code data written in the second language. This will be described in detail with reference to FIG. 5.

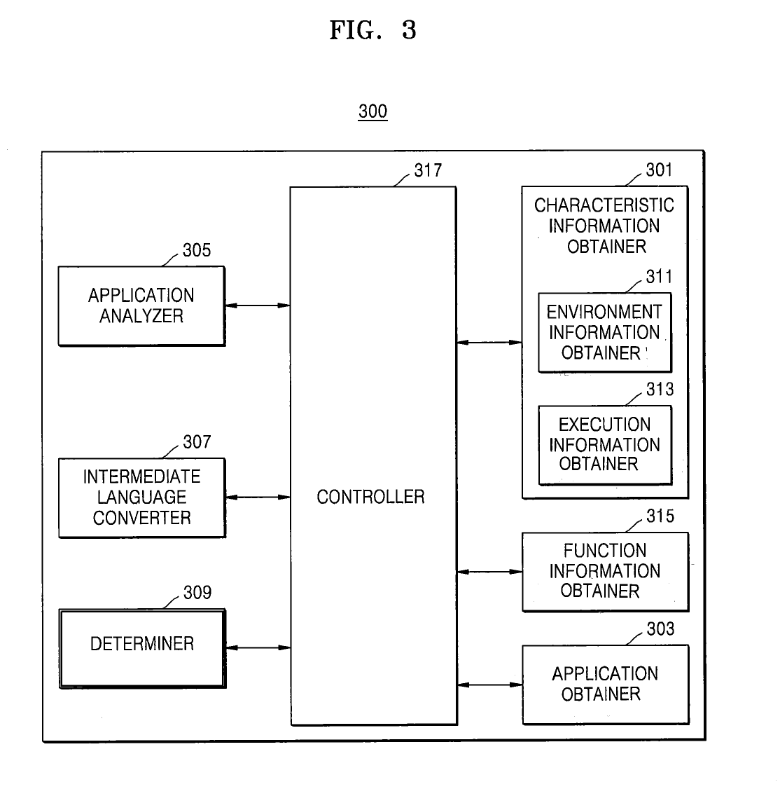

FIG. 3 illustrates a device 300 that analyzes an application, according to an exemplary embodiment.

As illustrated in FIG. 3, the device 300 may include a characteristic information obtainer 301, an application obtainer 303, an application analyzer 305, an intermediate language converter 307, a determiner 309, a controller 317, and a function information obtainer 315. However, not all of the elements shown in FIG. 3 are necessary elements. That is, the device 300 may be embodied with more or fewer elements than those shown in FIG. 3.

Hereinafter, the elements of FIG. 3 are described in detail.

In the present exemplary embodiment, the characteristic information obtainer 301 may include an environment information obtainer 311 and an execution information obtainer 313. In addition, the characteristic information obtainer 301 may include the function information obtainer 315.

The environment information obtainer 311 may obtain environment information about an environment of the device 300 in which the application is executed. The execution information obtainer 313 may obtain execution information about operations of components of the application.

In the present exemplary embodiment, the environment information may be information about the environment of the device 300 in which the application is executed and may include, but is not limited to, platform information, OS information, device ID information, and device performance information.

The execution information may be information about the operations of the components of the application and may include a plurality of pieces of information about operations of objects that configure the application.

The application obtainer 303 may obtain the application by using various methods.

The application obtainer 303 may obtain code data to be analyzed from the application, based on at least one of the environment information and the execution information. That is, based on at least one of the environment information and the execution information, the application obtainer 303 may select an application to be analyzed from among a plurality of applications or may select a target part of the code data of the application to analyze.

The application analyzer 305 may analyze the code data, based on function information obtained by the function information obtainer 315. Also, the application analyzer 305 may track a task that is performed by the application.

The intermediate language converter 307 may convert the code data that is obtained by the application obtainer 303 to an intermediate language code. Also, the intermediate language converter 307 may extract a non-executed component, based on the execution information, and may convert the code data that corresponds to components excluding the non-executed component, to the intermediate language code.

In addition, the intermediate language converter 307 may map one or more functions included in the code data to a group, according to a predetermined reference, and may convert the one or more functions in the group to an intermediate language code. Also, the intermediate language converter 307 may convert a function included in the code data to a combination of one or more intermediate language codes, according to a predetermined reference. In the present exemplary embodiment, the function may include an instruction.

The determiner 309 may determine, based on an analysis result from the application analyzer 305, whether the application provides an external device with an information resource of the device in which the application is executed. In addition, the determiner 309 may also provide a user with a result of determining whether the application performs a particular task.

The function information obtainer 315 may obtain the function information.

The function information may include operating information of an API provided by an OS or a platform, parameter information, and information about an operation of a function. Since this has already been described with reference to FIG. 1, detailed descriptions thereof are not repeated.

Furthermore, the function information obtainer 315 further includes an external reference information obtainer (not shown). The external reference information obtainer may obtain external reference information related to the code data

In the present exemplary embodiment, the controller 317 generally controls operations of the device 300. That is, the controller 317 may include a calculation unit such as a central processing unit (CPU), and may be included in another component. However, one or more exemplary embodiments are not limited thereto.

In addition, the device 300 may further include a user interface (UI) (not shown) that receives a user input, and a display (not shown) that displays an analysis result. Also, in the present exemplary embodiment, the device 300 may include a memory (not shown).

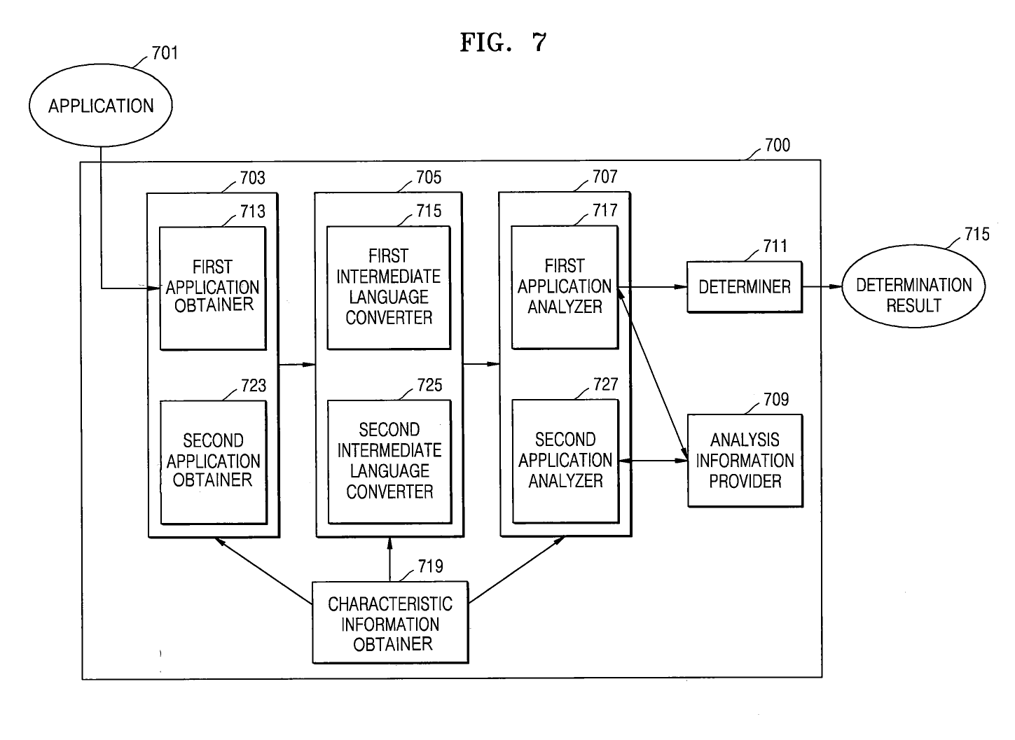

The device 300 may include an analysis information provider (not shown) for analyzing different types of codes. This will be described in detail with reference to FIG. 7.

FIG. 4 is a flowchart of a method of analyzing an application, according to another exemplary embodiment.

In operation S401, a device may obtain the application. Since operation S401 corresponds to operation S201 of FIG. 2, detailed descriptions thereof are not repeated.

In operation S403, the device may obtain environment information and execution information. Since the environment information and the execution information has already been described with reference to FIGS. 1 through 3, detailed descriptions thereof are not repeated.

In the present exemplary embodiment, as in operation S203 of FIG. 2, the device may obtain at least one of the environment information and the execution information.

In operation S405, the device may obtain code data to be analyzed from the application, based on the environment information. Also, as in operation S205 of FIG. 2, the device may obtain the code data to be analyzed from the application, based on at least one of the environment information and the execution information.

In operation S407, the device may convert the code data to be analyzed to an intermediate language code, based on the execution information.

In the present exemplary embodiment, the intermediate language code may indicate a result obtained by translating the code data of the application to an easily analyzable language. The application may include the code data that is written in a machine language or a language such as an assembly language that is similar to the machine language. For optimization, the code data written in the machine language or the assembly language may include many similar instructions in various forms.

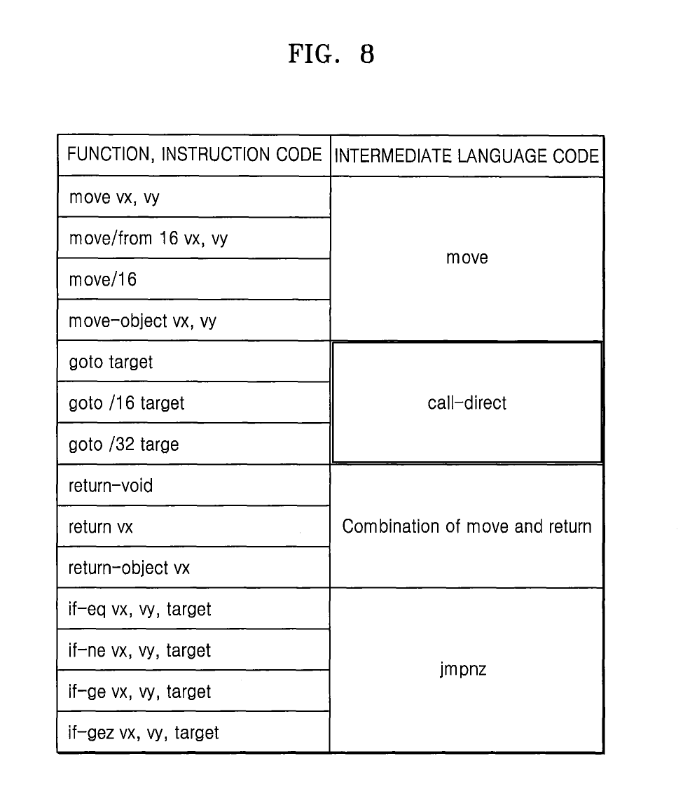

Thus, according to the present exemplary embodiment, in order to rapidly analyze the code data obtained from the application, the device may translate the similar instructions to one intermediate language code and thus may simplify a structure of the code data. This will be described in detail with reference to FIG. 8.

The device may extract, based on the execution information, a non-executed component in the code data, and may convert the code data that corresponds to components excluding the non-executed component, to the intermediate language code. In the present exemplary embodiment, the device does not analyze a part of the code data that is not translated to the intermediate language code.

The device may map one or more functions included in the code data to a group, according to a predetermined reference, and may convert the one or more functions in the group to the intermediate language code. Also, the device may convert a function included in the code data to a combination of one or more intermediate language codes, according to a predetermined reference.

In operation S409, the device may obtain function information. Since operation S409 corresponds to operation S207 of FIG. 2, detailed descriptions thereof are not repeated.

In operation S411, the device may analyze the intermediate language code, based on the function information.

The device may select, based on the environment information, the application to be analyzed or an analysis target part of the code data of the application, and may convert, based on the execution information, the code data to the intermediate language code. The code data excludes the non-executed component and a non-called component.

FIG. 5 is a flowchart of a method of analyzing an application, according to another exemplary embodiment.

In the present exemplary embodiment, code data of the application may be composed of different types of languages. For example, the code data of the application may include first code data written in a first language and second code data written in a second language.

The first language may be Java, and the second language may be a native language such as C or C++. Also, the first code data written in the first language may be executed in a first platform, and the second code data written in the second language may be executed in a second platform.

The first code data written in the first language may access the second code data written in the second language by using a programming framework. For example, the first code data written in the first language may call a function or a variable value in the second code data written in the second language by using the programming framework, such as an API.

In the present exemplary embodiment, the programming framework may include the API, such as a Java Network Interface (JNI).

According to the related art, code data that is composed of different languages is separately analyzed with respect to the different languages, and it is not possible to accurately analyze an operation that is performed by first code data written in a first language that accesses second code data written in a second language which is different from the first language. However, according to the present exemplary embodiment, the second code data written in the second language is analyzed and then analysis information about the second code data written in the second language is provided to the device that analyzes the first code data written in the first language. Thus, even when the code data is composed of different types of languages, the device may analyze all of the operations of the application that are performed by the code data.

In operation S501, the device may obtain the application. Since operation S501 corresponds to operation S201 of FIG. 2, detailed descriptions thereof are not repeated.

In operation S503, the device may obtain environment information and execution information. Since the environment information and the execution information correspond to those described with reference to FIGS. 1 through 4, detailed descriptions thereof are not repeated.

In operation S505, the device may obtain first code data written in a first language and second code data written in a second language from the application, based on the environment information. In the present exemplary embodiment, code data in the application may include the first code data written in the first language and the second code data written in the second language which is different from the first language.

In this regard, the device may separately obtain the first code data written in the first language and the second code data written in the second language. Alternatively, the device may divide the code data and thus may separately obtain the first code data written in the first language and the second code data written in the second language.

That is, according to the present exemplary embodiment, the device may select, based on the environment information, a part of the first code data written in the first language and a part of the second code data written in the second language. Alternatively, as described with reference to FIGS. 1 through 4, if the application stores a plurality of files of code data, the device may select one of the files, based on the environment information.

In operation S507, based on the execution information obtained in operation S503, the device may convert each of the first code data written in the first language and the second code data written in the second language to an intermediate language code.

The device may extract, based on the execution information, non-executed components from the first code data written in the first language and the second code data written in the second language, and may convert each of the first code data and the second code data to the intermediate language code, wherein the first code data and the second code data correspond to components of the application excluding the non-executed components.

In operation S509, the device may obtain analysis information about the second code data written in the second language that is converted in operation S507.

The device may analyze each of the converted first code data written in the first language and the converted second code data written in the second language. Alternatively, the device may select, based on a user input, one of the converted first code data written in the first language and the converted second code data written in the second language, and first analyzes the selected code data.

The analysis information about the converted second code data written in the second language may include variable information about a variable, function information, parameter information, or the like. The analysis information may also include a plurality of pieces of information that are stored in a memory of the device, in response to execution of a part of the converted second code data that is connected to the converted first code data written in the first language. For example, when the converted first code data written in the first language calls a variable that is defined in the converted second code data written in the second language, the analysis information about the converted second code data written in the second language may include information about the variable that is called by the converted first code data written in the first language, or information about a variable value stored in the memory.

In operation S511, the device may obtain the function information. Since operation S511 corresponds to operation S207 of FIG. 2, detailed descriptions thereof are not repeated.

In operation S513, the device may analyze the converted first code data written in the first language, based on the function information and the analysis information about the converted second code data written in the second language.

In the present exemplary embodiment, when the function or the object in the converted first code data written in the first language calls a function or an object defined in the second platform or the converted second code data written in the second language, the device may connect information about the memory of the device that stores a state of the function or the object before the call from the first code data, and may connect information about the memory of the device after the function or the object that is defined in the second platform or the converted second code data is called, so that the device may analyze the code data of the application that includes all of the first code data written in the first language and the second code data written in the second language.

Also, when the first code data written in the first language calls a variable that exists in the second platform or the second code data written in the second language, the device may determine a type of the variable in the second platform or the second code data, and thus may analyze the code data of the application.

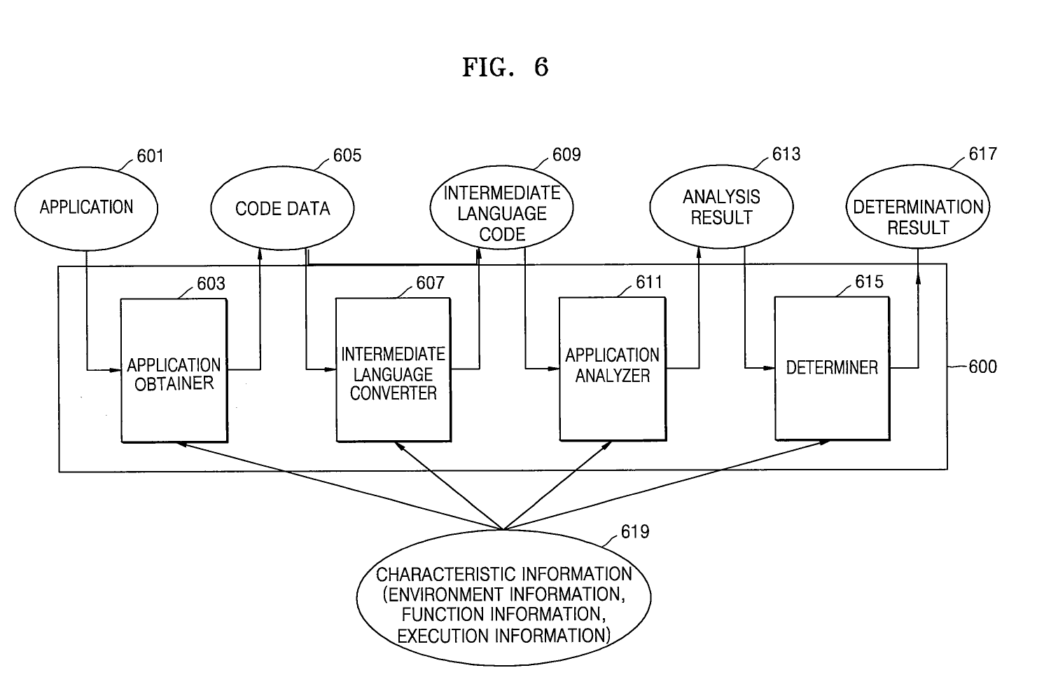

FIG. 6 is a flow diagram of analyzing an application 601, according to another exemplary embodiment.

In the present exemplary embodiment, a device 600 obtains the application 601 by using an application obtainer 603. As described with reference to FIGS. 1 through 5, throughout the specification, an application may mean a program including code data, and the types of application which can be used in the exemplary embodiments are not limited to a particular type of application.

The application obtainer 603 may extract code data 605 from the application 601. If the application obtainer 603 obtains a plurality of applications, the application obtainer 603 may select one of the plurality of applications and may obtain the code data 605 from the selected application.

Also, the application obtainer 603 may select and extract analysis-target code data, which is the code data which will be analyzed, based on characteristic information 619.

In the present exemplary embodiment, the characteristic information 619 may include environment information about the device 600 in which the plurality of applications may be executed, and thus, the application obtainer 603 may exclude, based on the environment information, an application that is not required for analysis, or code data of the application that is not required for the analysis.

An intermediate language converter 607 may convert the code data 605 to an intermediate language code.

In the present exemplary embodiment, the intermediate language converter 607 may convert the code data 605 to an intermediate language code 609, based on the characteristic information 619.

Since the characteristic information 619 includes execution information that is operating information about components of the application 601, the intermediate language converter 607 may convert the code data 605 to the intermediate language code 609. The code data 605 corresponds to the components of the application 601 and does not include a non-executed component.

An application analyzer 611 may analyze the intermediate language code 609. That is, the analyzer 611 may analyze the code data 605 that has been converted to the intermediate language code 609, and thus may analyze a task to be performed by the application 601 which includes the code data 605.

The analyzer 611 may analyze the intermediate language code 609, based on the characteristic information 619.

Since the characteristic information 619 includes function information, the analyzer 611 may estimate, based on the function information, an execution result with respect to the intermediate language code 609.

A determiner 615 may determine, based on an analysis result 613, whether the application 601 performs a specific task. In the present exemplary embodiment, the determiner 615 may determine, based on the analysis result 613, whether the application 601 transmits an information resource to an external device such as a server and/or other devices.

Also, the determiner 615 may provide a determination result 617 to a user. In the present exemplary embodiment, the determiner 615 may provide the determination result 617 by using one of various methods.

FIG. 7 illustrates a device 700 capable of analyzing an application 701, according to another exemplary embodiment.

A device 700 may include an application obtainer 703, an intermediate language converter 705, an application analyzer 707, an analysis information provider 709, a determiner 711, and a characteristic information obtainer 719.

The characteristic information obtainer 719 may obtain at least one of function information, execution information, and environment information. Since the function information, the execution information, and the environment information correspond to those described with reference to FIGS. 1 through 6, detailed descriptions thereof are not repeated.

The application obtainer 703 may include a first application obtainer 713 and a second application obtainer 723. The first application obtainer 713 may obtain first code data written in a first language from the application 701, and the second application obtainer 723 may obtain second code data written in a second language from the application 701.

The first application obtainer 713 and the second application obtainer 723 may select a part of the first code data written in the first language and a part of the second code data written in the second language, based on the environment information of the device 700 in which the application 701 is executed. The environment information is obtained by the characteristic information obtainer 719. Since operations of the application obtainer 703 correspond to those described with reference to FIGS. 1 through 6, detailed descriptions thereof are not repeated.

The intermediate language converter 705 may include a first intermediate language converter 715 and a second intermediate language converter 725. The first intermediate language converter 715 translates the first code data written in the first language obtained by the first application obtainer 713, to an intermediate language code, and the second intermediate language converter 725 may translate the second code data written in the second language obtained by the second application obtainer 723, to the intermediate language code.

The first intermediate language converter 715 may convert, based on the execution information obtained by the characteristic information obtainer 719, first code data to the intermediate language code, except for a part of the first code data that corresponds to a non-executed component from among components of the application 701. Also, the second intermediate language converter 725 may convert, based on the execution information, the second code data written in the second language to the intermediate language code. Since operations of the intermediate language converter 705 correspond to those described with reference to FIGS. 1 through 6, detailed descriptions thereof are not repeated.

The application analyzer 707 may include a first application analyzer 717 and a second application analyzer 727. The first application analyzer 717 may analyze the first code data written in the first language that is converted by the first intermediate language converter 715. The second application analyzer 727 may analyze the second code data written in the second language that is converted by the second intermediate language converter 725.

The first application analyzer 717 and the second application analyzer 727 may analyze the first code data written in the first language and the second code data written in the second language, respectively, based on the function information obtained by the characteristic information obtainer 719. Since operations of the application analyzer 707 correspond to those described with reference to FIGS. 1 through 6, detailed descriptions thereof are not repeated.

The analysis information provider 709 may obtain an analysis result from the first application analyzer 717 or the second application analyzer 727. Also, the analysis information provider 709 may provide the analysis result that is received from the first application analyzer 717 to the second application analyzer 727, or vice versa. That is, the first application analyzer 717 may analyze the first code data written in the first language, based on the analysis result from the second application analyzer 727 and the function information obtained by the characteristic information obtainer 719.

For example, when the first code data written in the first language calls a variable or a function defined in the second code data written in the second language, the analysis information provider 709 may provide, to the first application analyzer 717, the variable that is defined in the second code data called by the first code data and the function information which are included in the analysis result with respect to the second code data. Therefore, the application analyzer 707 can analyze operations of the application 701.

The determiner 711 may determine, based on an analysis result from the application analyzer 707, whether the application 701 performs a particular task. In the present exemplary embodiment, the determiner 711 may determine whether the application 701 transmits an information resource of the device 700 to an external device.

Also, the determiner 711 may provide a determination result 715 to a user.

FIG. 8 illustrates an example of converting to an intermediate language code, according to an exemplary embodiment.

In the present exemplary embodiment, a device may convert code data to an intermediate language code. The code data included in an application is written in a machine language or a language such as an assembly language which is similar to the machine language. For optimization, the machine language or the assembly language includes many similar functions or instructions in various forms. Therefore, the device groups the similar functions or instructions so as to simplify the code data, and converts the code data.

Referring to FIG. 8, a function and instruction code field indicates functions and instruction codes that are included in the code data. Since “move vx, vy”, “move/from 16 vx, vy”, or the like in the code data include a common performance related to ‘move’, the device may convert “move vx, vy”, “move/from 16 vx, vy”, or the like to an intermediate language code indicating ‘move’.

In the present exemplary embodiment, function and instruction codes such as “return-void” and “return vx” are not converted to one intermediate language code, but can be converted to a combination of intermediate language codes.

The present exemplary embodiment is not limited to the example of FIG. 8 in which the function and instruction codes are converted to the intermediate language code. That is, the instructions included in the code data may be converted to an intermediate language code according to settings by a developer.

In the present exemplary embodiment, the device may map one or more functions included in the code data to a group, according to a predetermined reference, and may convert the one or more functions included in the group to an intermediate language code. Also, the device may convert the one or more functions to a combination of one or more intermediate language codes, according to another predetermined reference.

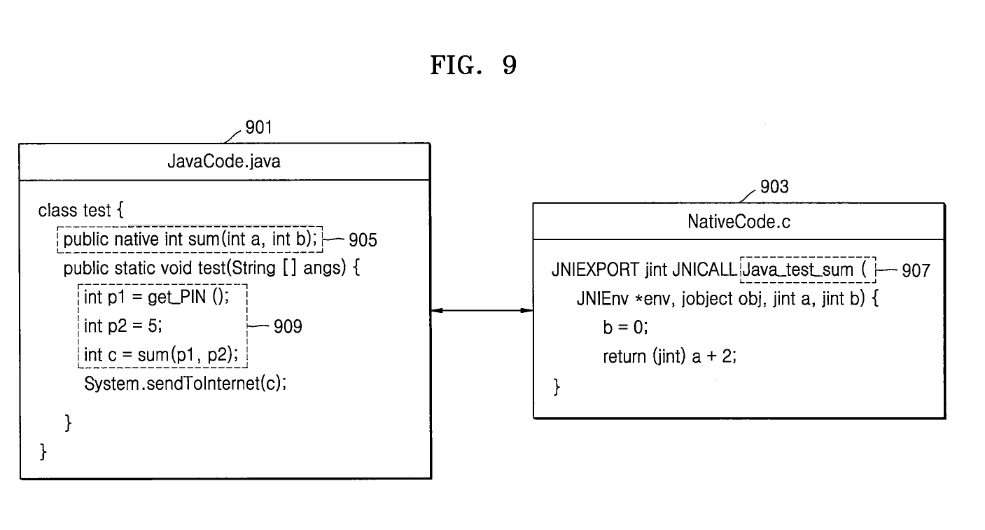

FIG. 9 illustrates a method of analyzing code data composed of different types of languages, according to an exemplary embodiment.

In the present exemplary embodiment, a device may analyze the code data composed of different types of languages. That is, when an analysis-target application includes the code data which includes first code data 901 written in a first language and second code data 903 written in a second language, the device may analyze the first code data 901 by using an analysis result with respect to the second code data 903, as described with reference to FIG. 7.

Referring to FIG. 9, the first code data 901 may be code data written in a Java language, and the second code data 903 may be code data written in a C language. A part 905 that is written in the first code data 901 defines a sum function to be called from the second code data 903. Also, the first code data 901 includes a part 909 that defines a variable p1 that stores PIN information, a variable p2 that stores a constant 5, and a variable c that is a result of processing the variable p1 and p2 by using the sum function.

In the present exemplary embodiment, a call between the first code data 901 and the second code data 903 may be performed according to the Java Native Interface (JNI) specification.

Referring to FIG. 9, since the first code data 901 is set to transmit information stored in the variable c to an external network, such as the Internet. The device must analyze information included in the variable c. According to the related art, the device cannot obtain information about a sum function defined in code data composed of different types of languages. Thus, the device cannot accurately analyze an operation of the application.

However, according to the present exemplary embodiment, the device may analyze the second code data 903 written in the second language and thus may obtain information about an operation of a sum function that is called by the first code data 901 written in the first language. Referring to FIG. 9, the sum function defined in the second code data 903 involves adding “2” to a first variable a.

The device may analyze the first code data 901 by using an analysis result with respect to the second code data 903, and thus may analyze the code data of the application. Referring to FIG. 9, the device may obtain the information about the operation of the sum function and may recognize, based on the obtained information, that the variable c includes the information related to the PIN information. Thus, since the application transmits the information included in the variable c to an external network, the device may determine that the application including the analyzed code data may externally provide an information resource of the device.

According to the related art, since the device cannot obtain information about an operation of a function and a variable defined in the second code data 903, the device has to track all variables and operations of functions in the first code data 901 in order to analyze the application. However, according to the present exemplary embodiment, the device may analyze the first code data 901, based on analysis information with respect to the second code data 903, and thus, the device may analyze the application, except for variables that are unnecessary with respect to the tracking of the code data.

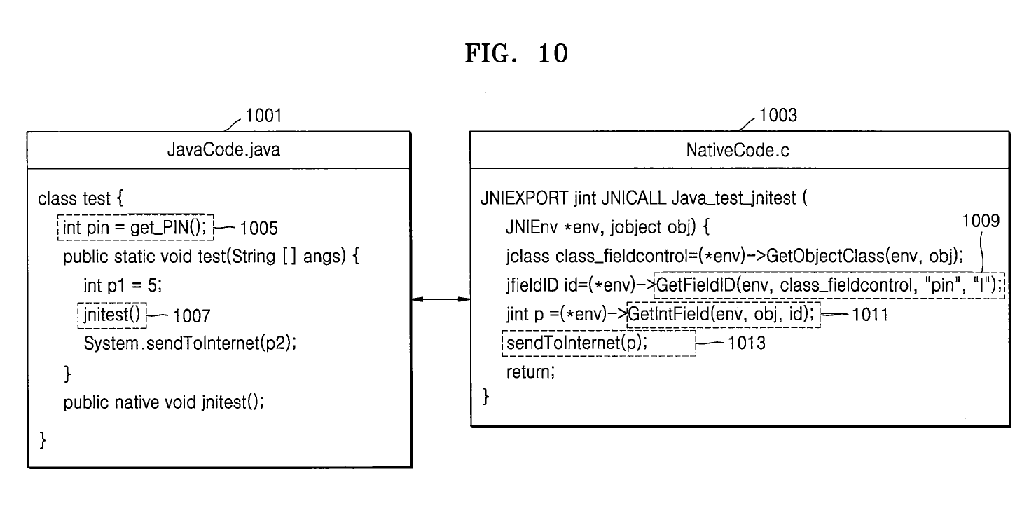

That is, the analysis information provider 709 of FIG. 7 may provide information about a function, an object, and a variable included in the second code data 903 shown in FIG. 9 to the application analyzer 707 that analyzes the first code data 901, and thus may allow the application analyzer 707 to accurately analyze the first code data 901. FIG. 10 illustrates an example similar to that of FIG. 9.

FIG. 10 illustrates a method of analyzing code data composed of different types of languages, according to another exemplary embodiment.

Referring to FIG. 10, the code data includes first code data 1001 written in a first language and second code data 1003 written in a second language. The first code data 1001 may be code data written in a Java language, and the second code data 1003 may be code data written in a C language.

In the present exemplary embodiment, the first code data 1001 includes a part 1005 that defines a variable ‘pin’ that stores PIN information and a part 1007 that defines a function ‘jnitest’. The function ‘jnitest’ is also defined in the second code data 1003.

In FIG. 10, in the second code data 1003, the function ‘jnitest’ includes a part 1009 that calls a pin function from the first code data 1001, a part 1011 that stores information about the called pin function in a variable p, and a part 1013 that transmits the information stored in the variable p to an external network, such as the Internet.

According to the related art, a device cannot recognize information about a variable that the second code data 1003 obtains from the first code data 1001, thus, it is difficult for the device to accurately analyze the second code data 1003. However, according to an exemplary embodiment, the device analyzes the second code data 1003 by using information about a variable that is called from the first code data 1001. Thus, the device can accurately analyze the second code data 1003.

As described above, according to the one or more of the above exemplary embodiments, the methods and devices may improve accuracy and performance of the static analysis method.

The one or more exemplary embodiments may include a processor, a memory for storing and executing program data, permanent storage including a disk drive, a communication port for communication with an external device, a user interface device including a touch panel, a key, a button, and the like. The methods embodied as a software module or an algorithm may be stored as computer readable codes or program commands that are executable on the processor in a computer readable recording medium. The computer readable recording medium is any data storage device that can store data which can be thereafter read by a computer system. Examples of the computer readable recording medium include magnetic storage mediums (e.g., hard disks, etc) and optical reading mediums including CD-ROMs, DVDs, etc. The computer-readable recording medium can also be distributed over network-coupled computer systems so that the computer-readable code is stored and executed in a distributed fashion. The mediums can be read by computers, can be stored in the memory, and can be executed on the processor.

For purposes of better understanding the principles of the exemplary embodiments, reference has been made to the exemplary embodiments illustrated in the drawings, and specific language has been used to describe these exemplary embodiments. However, no limitation to the scope of the exemplary embodiments is intended by this specific language, and the exemplary embodiments should be construed to encompass all exemplary embodiments that would be clear to one of ordinary skill in the art.

The one or more exemplary embodiments may be described in terms of functional block components and various processing steps. Such functional blocks may be realized by any number of hardware and/or software components configured to perform the specified functions. For example, the one or more exemplary embodiments may employ various integrated circuit components, e.g., memory elements, processing elements, logic elements, look-up tables, and the like, which may carry out a variety of functions under the control of one or more microprocessors or other control devices. Similarly, where the elements are implemented using software programming or software elements, the exemplary embodiments may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the one or more exemplary embodiments could employ any number of conventional techniques for electronics configuration, signal processing and/or control, data processing and the like. The words ‘mechanism’ and ‘element’ are used broadly and are not limited to mechanical or physical exemplary embodiments, but can include software routines in conjunction with processors, etc.

The particular implementations shown and described herein are illustrative examples of the exemplary embodiments and are not intended to otherwise limit the scope of the exemplary embodiments in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the exemplary embodiments unless the element is specifically described as ‘essential’ or ‘critical’.

The use of the terms ‘a’ and ‘an’ and ‘the’ and similar referents in the context of describing the exemplary embodiments (especially in the context of the following claims) are to be construed to cover both the singular and the plural. Furthermore, a recitation of ranges of values herein are merely intended to serve as a shorthand method of referring individually to each separate value falling within the range, unless otherwise indicated herein, and each separate value is incorporated in the specification as if it were individually recited herein. Finally, the steps of all methods described herein can be performed in any suitable order unless otherwise indicated herein or otherwise clearly contradicted by context. The use of any and all examples, or exemplary language (e.g., ‘such as’) provided herein, is intended merely to better illuminate the exemplary embodiments and does not pose a limitation on the scope of the exemplary embodiments unless otherwise claimed. Numerous modifications and adaptations will be readily apparent to those of ordinary skill in this art without departing from the spirit and scope of the exemplary embodiments.

What is claimed is:

1. A method of analyzing an application which is performed by a device, the method comprising:
obtaining the application;
obtaining at least one of environment information of the device, which is information about an environment where the application is executed, and execution information, which is information about operations of components of the application;
obtaining code data to analyze from the application, based on at least one of the environment information and the execution information;
obtaining function information; and
analyzing the code data based on the obtained function information.

2. The method of claim 1, further comprising converting the code data to an intermediate language code, and
wherein the analyzing the code data comprises analyzing the intermediate language code based on the function information.

3. The method of claim 2, wherein the code data of the application comprises first code data written in a first language and second code data written in a second language,
wherein the converting the code data to the intermediate language code comprises converting each of the first code data written in the first language and the second code data written in the second language to the intermediate language code, based on the execution information, and
wherein the analyzing the code data comprises analyzing the converted first code data written in the first language and analyzing the converted second code data written in the second language, based on the function information.

4. The method of claim 3, wherein the analyzing the converted first code data comprises:
obtaining analysis information with respect to the converted second code data written in the second language; and
analyzing the converted first code data written in the first language, based on the function information and the analysis information with respect to the converted second code data written in the second language.

5. The method of claim 2, wherein the converting the code data comprises:
extracting a non-executed component of application, based on the execution information; and
converting the code data that corresponds to the components of the application, excluding the non-executed component of the application, to the intermediate language code.

6. The method of claim 2, wherein the converting the code data comprises mapping one or more functions in the code data to a group, according to a predetermined reference, and converting the one or more functions in the group to the intermediate language code.

7. The method of claim 2, wherein the converting the code data comprises converting a function in the code data to a combination of one or more intermediate language codes, according to a predetermined reference in the code data.

8. The method of claim 1, further comprising determining, based on a result of the analyzing the code data, whether the application transmits an information resource of the device to an external device.

9. The method of claim 1, further comprising converting the code data to an intermediate language code;
obtaining external reference information related to the code data of the application, and
wherein the analyzing comprises analyzing the intermediate language code based on the function information and the external reference information.

10. The method of claim 1, wherein the analyzing comprises tracking a task to be performed by the application, based on the obtained function information.

11. The method of claim 1, wherein the obtained function information comprises at least one of application programming interface (API) operating information, API parameter information, and function operating information.

12. The method of claim 1, wherein the environment information of the device comprises at least one of operating system (OS) information and platform information of the device.

13. The method of claim 1, wherein the execution information comprises lifecycle information about each of the components of the application.

14. A device configured to analyze an application, the device comprising:
a characteristic information obtainer configured to obtain at least one of environment information of the device, which is information about an environment where the application is executed, and execution information, which is information about operations of components of the application;
an application obtainer configured to obtain the application and configured to obtain code data to analyze from the application, based on at least one of the environment information and the execution information;
a function information obtainer configured to obtain function information; and
an application analyzer configured to analyze the code data, based on the obtained function information.

15. The device of claim 14, further comprising an intermediate language converter configured to convert the code data to an intermediate language code, and
wherein the application analyzer analyzes the intermediate language code, based on the obtained function information.

16. The device of claim 15, wherein the code data of the application comprises first code data written in a first language and second code data written in a second language,
wherein the intermediate language converter is configured to convert each of the first code data written in the first language and the second code data written in the second language to the intermediate language code, based on the execution information, and
wherein the application analyzer is configured to analyze the converted first code data written in the first language and configured to analyze the converted second code data written in the second language, based on the function information.

17. The device of claim 16, further comprising an analysis information provider configured to obtain analysis information with respect to the converted second code data written in the second language, and
wherein the application analyzer is configured to analyze the converted first code data written in the first language, based on the function information and the analysis information with respect to the converted second code data written in the second language.

18. The device of claim 15, wherein the intermediate language converter is configured to extract a non-executed component of the application, based on the execution information, and configured to convert the code data that corresponds to the components of the application excluding the non-executed component, to the intermediate language code.

19. The device of claim 15, wherein the intermediate language converter is configured to map one or more functions in the code data to a group, according to a predetermined reference, and configured to convert the one or more functions in the group to the intermediate language code.

20. The device of claim 15, wherein the intermediate language converter is configured to convert a function in the code data to a combination of one or more intermediate language codes, according to a predetermined reference in the code data.

21. The device of claim 14, further comprising a determiner configured to determine, based on a result of the analyzing, whether the application transmits an information resource of the device to an external device.

22. The device of claim 14, further comprising an external reference information obtainer configured to obtain external reference information related to the code data of the application, and
wherein the application analyzer is configured to analyze the intermediate language code, based on the function information and the external reference information.

23. The device of claim 14, wherein the application analyzer is configured to track a task to be performed by the application, based on the function information.

24. The device of claim 14, wherein the function information comprises at least one of application programming interface (API) operating information, API parameter information, and function operating information.

25. The device of claim 14, wherein the environment information of the device comprises at least one of operating system (OS) information and platform information of the device.

26. The device of claim 14, wherein the execution information comprises lifecycle information about each of the components of the application.

27. A non-transitory computer-readable recording medium having recorded thereon a program which is executed by a computer to perform the method of claim 1.
